(19) United States
(12) Patent Application Publication
(10) Pub. No.: US 2007/0214078 A1
(43) Pub. Date: Sep. 13, 2007

(54) Bill payment apparatus and method

(75) Inventor: James B. Coppinger, Chattanooga, TN (US)

Correspondence Address: LUEDEKA, NEELY & GRAHAM, P.C., P O BOX 1871, KNOXVILLE, TN, 37901, US

(73) Assignee: Transpayment, Inc.

(21) Appl. No.: 11/236,917

(22) Filed: Sep. 28, 2005

(51) Int. Cl. G06Q 40/00; H04M 15/00; G07F 19/00

(52) U.S. Cl. 705/39; 705/34

(57) ABSTRACT

The invention provides a method of processing the payment of a bill on behalf of a payee to a billing entity that issued the bill. The payee takes the bill to a service center, such as located in a convenience store or check cashing store, and presents the bill to a clerk. At the service center, an electronic image of the bill is generated such as using a scanner. The scanned image is then transmitted from the service center to a central bill payment service via a communication network, such as the Internet. At the central bill payment service, bill payment information is extracted from the image of the bill. A monetary amount to be paid to the billing entity is designated by the payee, and payment of the amount to the billing entity is initiated by the central bill payment service on behalf of the payee. The payee may choose to have the payment made by electronic funds transfer, by check or by priority payment via a credit card account or a debit card account. In a preferred embodiment, the method includes identifying fields within the image of the bill that contain the bill payment information, recognizing characters within the fields and extracting the bill payment information from the recognized characters.

### FIELD

This invention relates to the field of monetary transfers. More particularly, this invention relates to a system for permitting consumers to pay bills at a service center.

### BACKGROUND

As part of a process for collecting payment for services provided to a customer, the service provider may send an invoice, or bill, to the customer. This bill may be sent via mail, facsimile, email or other means. In most instances, the bill indicates an amount due by a certain date and an address to which payment is to be sent. Usually, the bill will also indicate a customer account number and an invoice number.

Traditionally, a customer would pay such a bill by writing a check to the service provider and placing the check in the mail. At a minimum, this operation requires an envelope, a postage stamp and a check. More recently, customers have been able to pay bills electronically using on-line bill payment services. To use such on-line services, the customer must have personal access to a computer that can connect to the bill payment service, such as via the Internet. In most instances, the customer must also have a credit or debit card, or other monetary account that is electronically accessible.

Some consumers do not have checking accounts, and thus cannot send checks to pay bills. Some consumers do not have access to a computer connected to the Internet, or do not have debit, credit or other electronically accessible accounts necessary to payment of bills via traditional on-line bill payment services. Some consumers simply do not wish to be bothered with having to write a check, or sit down at a computer and access a website to pay a bill.

What is needed, therefore, is a quick and convenient means for payment of bills that avoids the difficulties associated with prior bill payment methods.

### SUMMARY

The above and other needs are met by a method of processing the payment of a bill on behalf of a payee to a billing entity that issued the bill. According to the invention, the payee takes the bill to a service center, such as located in a convenience store or check cashing store, and presents the bill to a clerk. At the service center, an electronic image of the bill is generated such as using a scanner. The scanned image is then transmitted from the service center to a central bill payment service via a communication network, such as the Internet. At the central bill payment service, bill payment information is extracted from the image of the bill. A monetary amount to be paid to the billing entity is designated by the payee based on the bill payment information. Payment of the amount to the billing entity is then initiated by the central bill payment service on behalf of the payee.

Since all processing of the bill payment transaction is carried out by computers at the service center and the bill payment service, the payee does not need personal access to a computer or to the Internet. Also, the payee does not need a checking account, a credit card or postage stamps.

In one embodiment of the invention, the method includes identifying fields within the image of the bill that contain the bill payment information, recognizing characters within the fields and extracting the bill payment information from the recognized characters. These steps of the method are preferably performed at the bill payment service computer.

According to one preferred embodiment, step (e) of the method includes offering several options to the payee for the manner of paying the monetary amount to the billing entity. The method also includes steps of receiving instructions from the payee regarding a selection of one of the options, and paying the monetary amount to the billing entity according to the selection made by the payee. The payment options may include electronic funds transfer, payment by check, and priority payment via a credit card account or a debit card account.

In another aspect, the invention provides an apparatus for processing payment of a bill on behalf of a payee to a billing entity that issued the bill. The apparatus includes means provided at a service center for generating an electronic image of the bill, means for transmitting the image of the bill from the service center to a central bill payment service via a communication network, means provided at the central bill payment service for extracting bill payment information from the image of the bill, means provided at the service center for designating a monetary amount to be paid to the billing entity based at least in part on the bill payment information, and means for initiating payment of the monetary amount to the billing entity on behalf of the payee.

In yet another aspect, the apparatus comprises a service center computing system in communication with a communication network, such as the Internet. The service center computing system includes an image scanning device for generating an electronic image of the bill and a service center computer connected to the scanning device. The service center computer receives the image of the bill from the image scanning device, transmits the image of the bill via the communication network, and designates a monetary amount of the bill to be paid to the billing entity. The apparatus also comprises a bill payment service computing system connected to the communication network. The bill payment service computing system includes a bill payment server computer that receives the image of the bill from the communication network, extracts bill payment information from the image of the bill and initiates payment of the monetary amount to the billing entity on behalf of the payee. In a preferred embodiment, the bill payment service computing system includes a billing entity database for storing the bill payment information and a bill image database for storing the image of the bill.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a bill payment system according to a preferred embodiment of the invention;

FIGS. 2A-2C depict flow charts of a method for paying bills according to a preferred embodiment of the invention; and

FIGS. 3-10 represent computer display screen shots depicting a method for paying bills according to a preferred embodiment of the invention.

### DETAILED DESCRIPTION

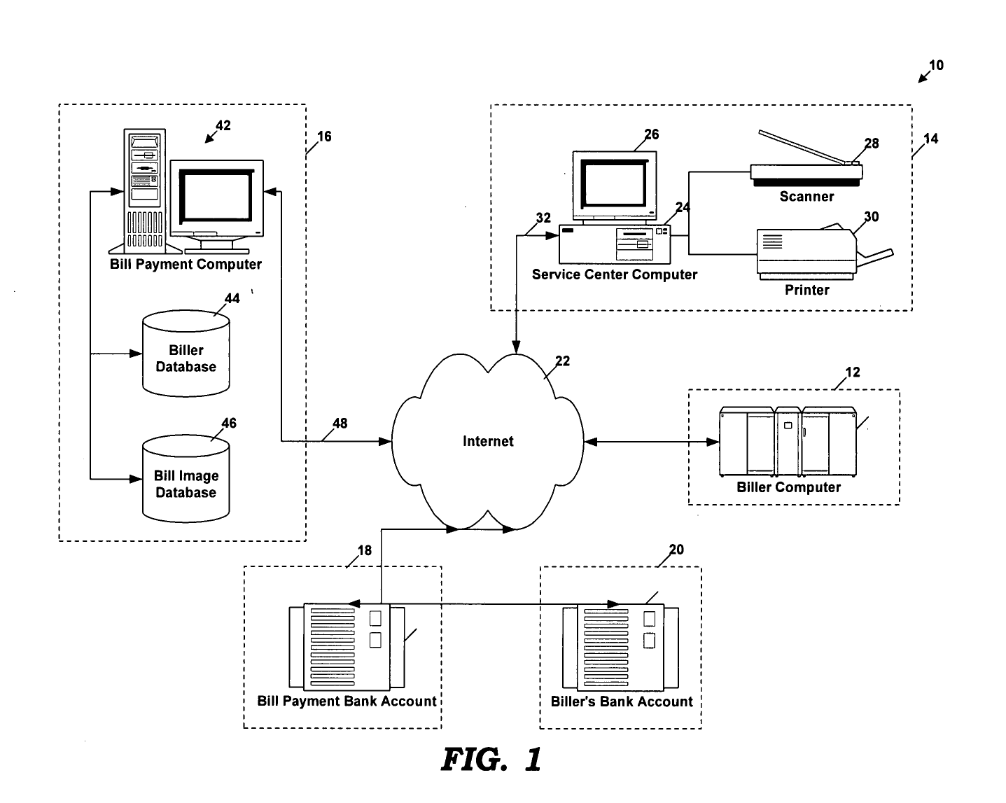

FIG. 1 depicts a bill payment system 10 according to a preferred embodiment of the invention. The system 10 involves a billing entity or “biller” 12, a service center 14, a bill payment service 16, the bill payment service's bank 18, the billing entity's bank 20 and a communication network 22, such as the Internet or a virtual private network (VPN).

In a preferred embodiment of the invention, the service center 14 is a check cashing store, a convenience store, a wireless phone store, a shopping mall kiosk or other “storefront” that has entered into an agreement to handle payment of customers' bills using the system described herein. As described in more detail below, the service center 14 collects cash from customers for settlement of bills and deposits all net receipts in an account that is accessible by the bill payment service 16. To pay the customer's bill, the bill payment service 16, such as Transpayment, Inc., accesses the account to electronically transfer funds to the biller 12 or the biller's bank 20, such as through the Federal Reserve Automated Clearing House (ACH) system.

As shown in FIG. 1, the service center 14 preferably includes a service center computer 24, a display device 26, a scanner 28, a printer 30 and a connection 32 to the communication network 22. The bill payment service 16 preferably includes a server computer 42, a biller database 44, a bill image database 46 and a connection 48 to the communication network 22. The biller database 44 stores information on all billers 12 known to the bill payment service 16. The bill image database 46 stores scanned images of bills that have been processed.

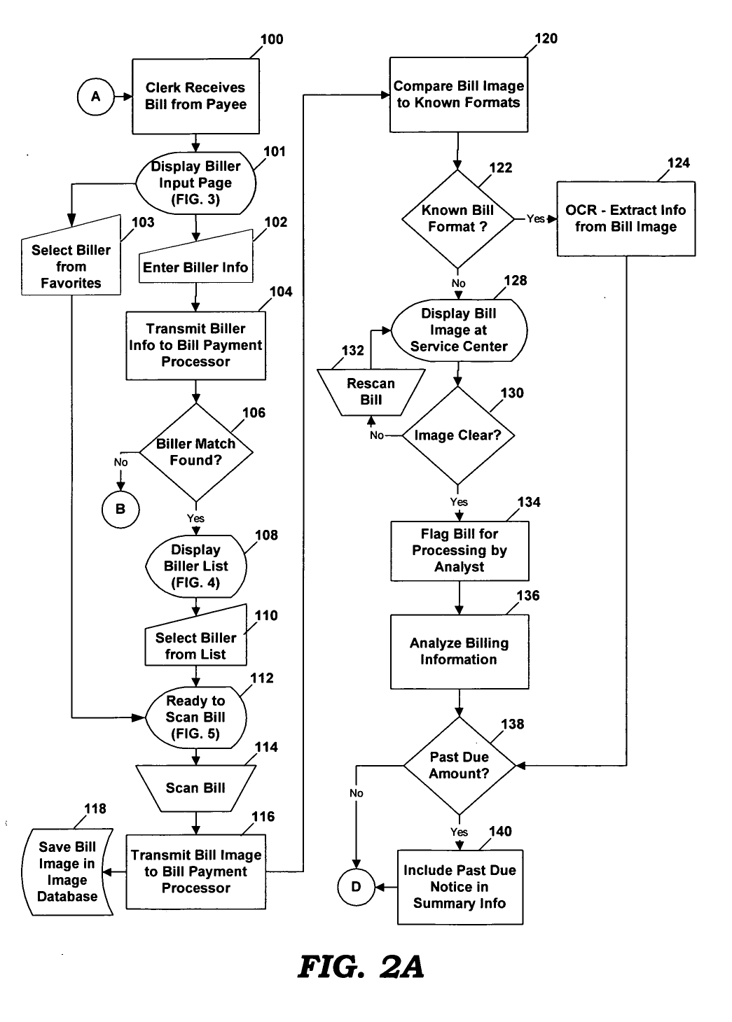

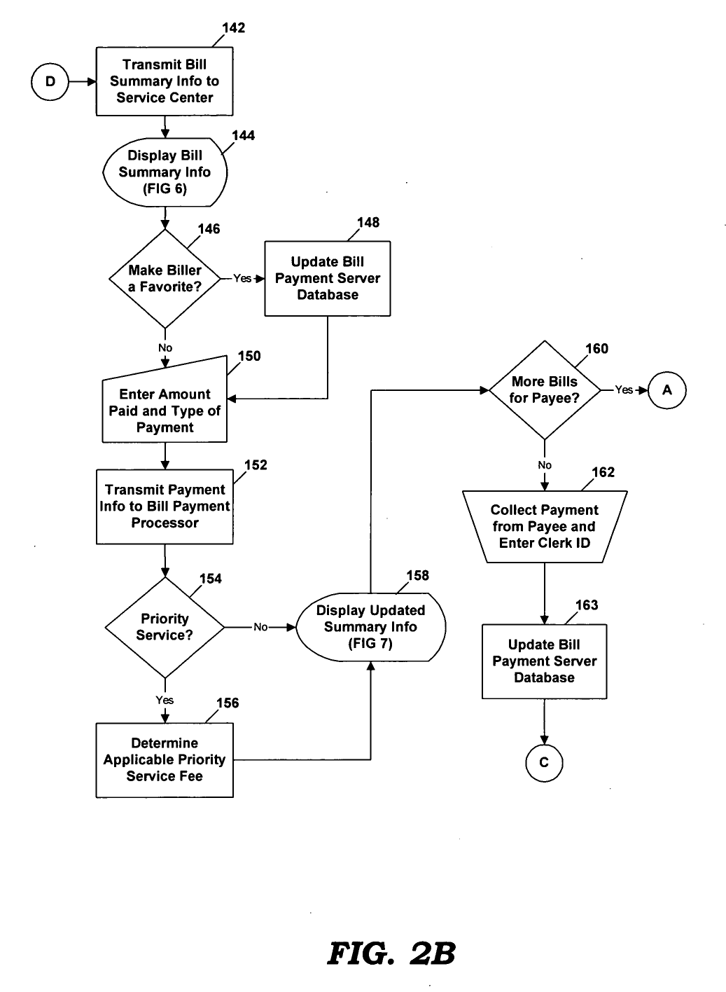

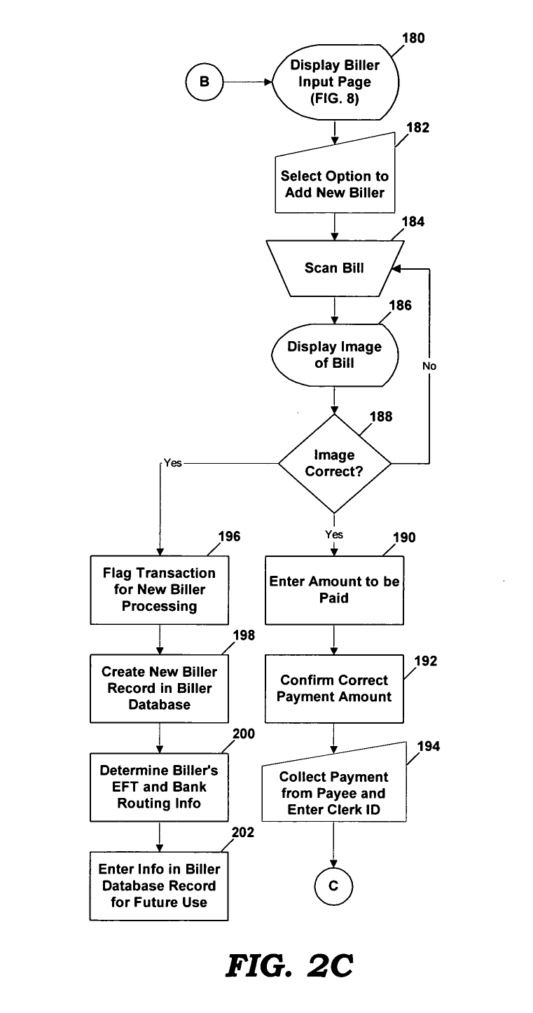

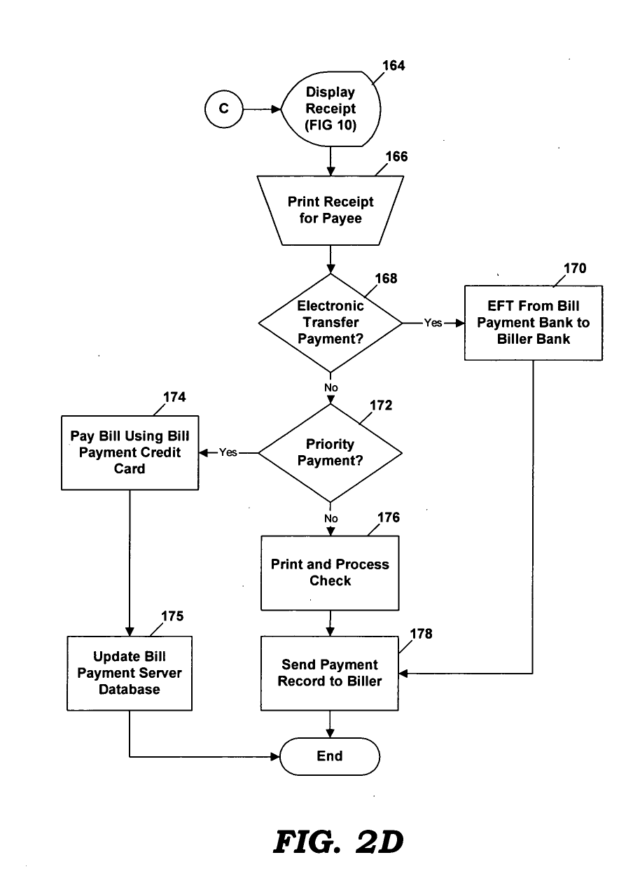

With reference to FIGS. 1, 2A and 3, when a customer, also referred to herein as a “payee,” wishes to pay one or more bills, the customer presents the bill or bills to a clerk at the service center 14 (step 100 in FIG. 2A). To begin the transaction, a biller input screen is displayed on the display device 26 of the service center computer 24 (step 101.)

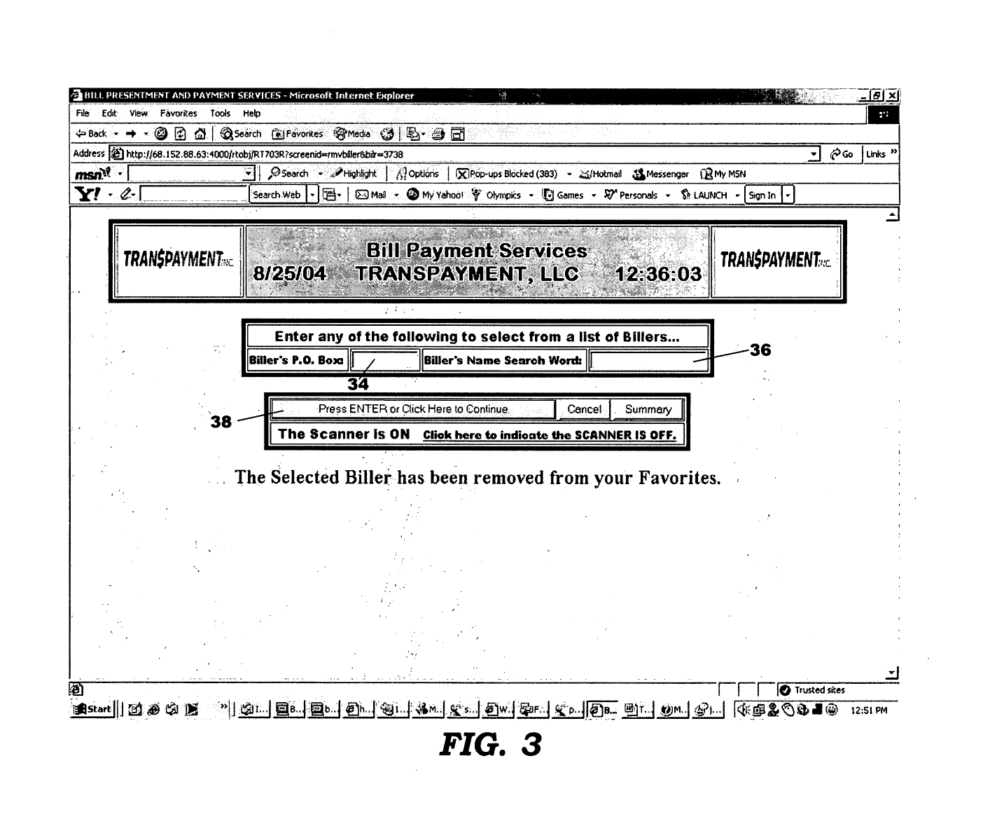

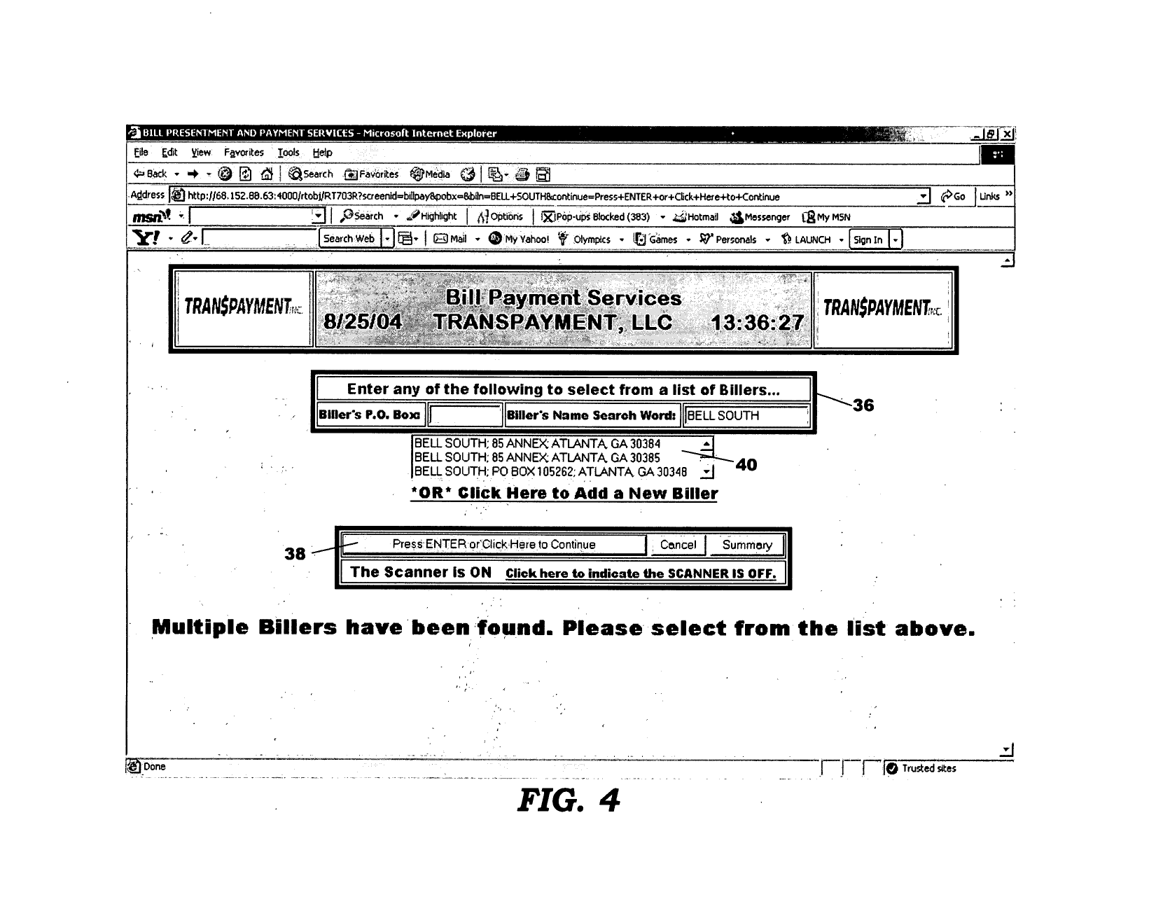

An example of the biller input screen is depicted in FIG. 3. Based on information printed on the bill, the clerk uses the computer 24 to enter data that identifies the biller 12 (step 102). That information may be entered, for example, by typing the PO box number of the biller 12 in a dialog box 34 or by entering search words from the name of the biller 12 in the dialog box 36 (FIG. 3). The biller identification information is then transmitted over the communication network 22 to the bill payment service 16 (step 104). If one or more billers match the information entered in boxes 34 or 36 (step 106), a list 40 of the matching billers is presented as shown in FIG. 4 (step 108). The clerk selects a biller from the list and clicks on the “enter” button 38 (step 110).

Alternatively, the biller may be selected from a list of favorites (step 103). In this case, processing continues at step 112 of FIG. 2A as discussed hereinafter.

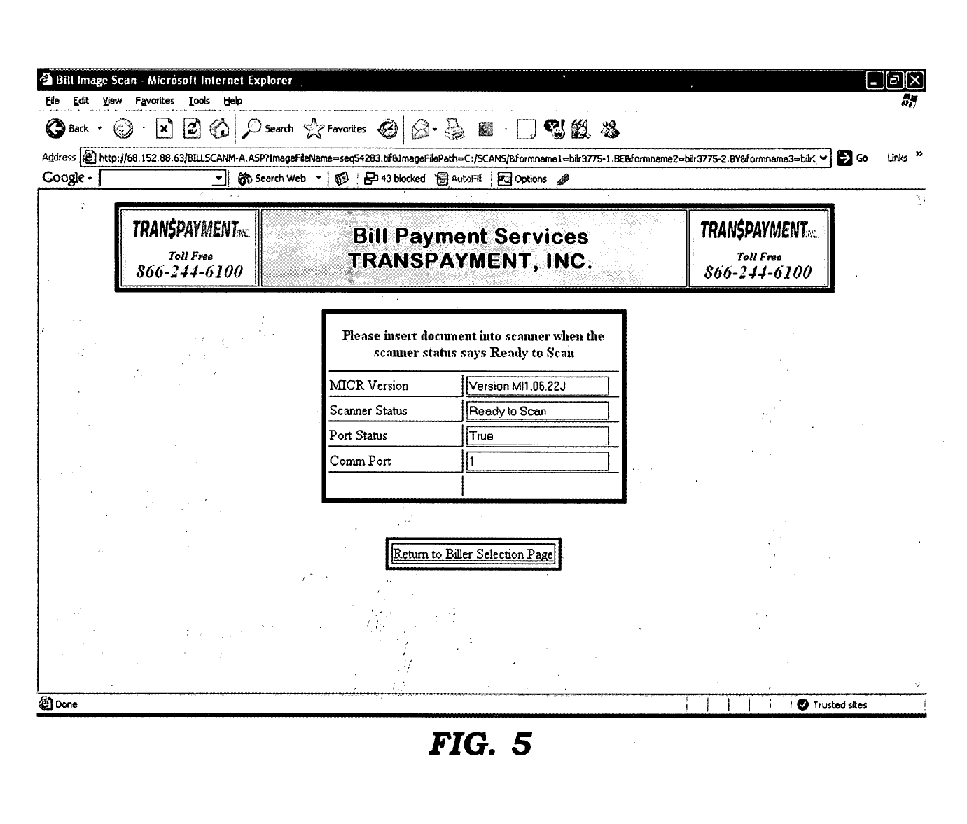

Once the bill payment server computer 42 receives the biller information from the service center 14, the computer 42 sends a message to the service center computer 24 that is displayed on the display device 26 to prompt the clerk to scan the bill (step 112). An example of the prompt screen is depicted in FIG. 5. The clerk then places the payee's bill in the scanner 28 which activates the scanner 28 to scan the bill (step 114). The scanned image of the bill is transmitted over the communication network 22 to the bill payment server computer 42 (step 116) and the scanned image is saved in the bill image database 46 (step 118).

The bill payment server computer 42 compares the image to other images in the image database 46 associated with the biller (step 120). The comparison is performed using image analysis and Optical Character Recognition (OCR) software that allows for the creation of a “form” for each image associated with the biller 12. For purposes of this description, a form is a collection of target fields and data fields. In the preferred embodiment of the invention, target fields are distinct and consistent parts of the image that are used by the image analysis software to align the image being analyzed. Data fields are parts of the image containing data needed for processing the bill.

If the layout of information in the image matches a previously-known format (step 122), the computer 42 locates the pre-defined target fields/datums in the image to position and align the image, and extracts billing information from the data fields (step 124). Input fields in the image may include alphanumeric characters, magnetic ink character recognition fonts, or optical character recognition fonts. In the preferred embodiment, the billing information is extracted using OCR software, such as Quickstrokes software from Mitek. Processing then continues at step 138 (FIG. 2A) as described below.

If an established biller was selected (see FIG. 4) but the scanned image does not match any of the forms for the biller stored in the biller database 44 (step 122), the image is displayed for the clerk on the display device 26 of the service center system 14 (step 128). An example of this screen is depicted in FIG. 11. The clerk is prompted to view the image and verify its existence and that it is clear and undistorted. As indicated in FIG. 11, if the image is clear and undistorted (step 130) the clerk is prompted to continue with the transaction. If the image is not clear, the clerk is prompted to rescan the bill (step 132).

Once a clear image is available, the transaction is flagged in the bill payment server computer 42 so that an analyst associated with the bill payment service can review the bill image and create a new form to be associated with the image (step 134). The new form is used to automatically return the data for any future bills with the same image.

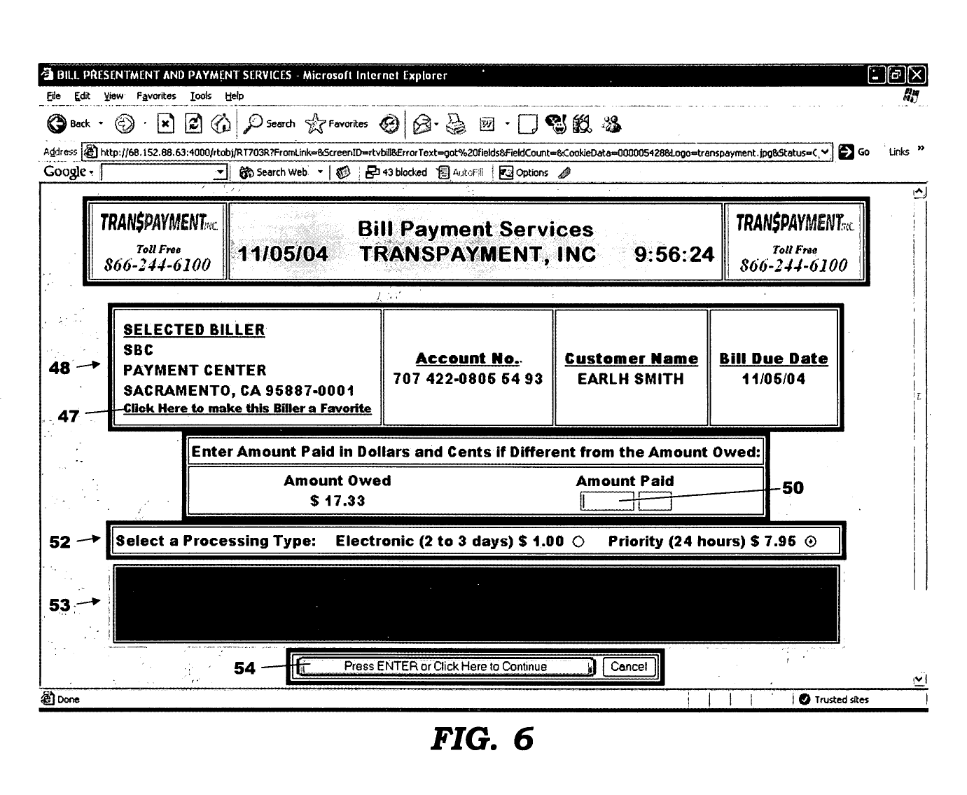

Once billing information from the scanned image is successfully retrieved, the billing information is analyzed by the bill payment server computer 42 and summary information is generated (step 136). Special alerts are provided if the bill includes a past due date or amount, the bill represents an apparent duplicate entry, or other situation occurs that requires special attention (steps 138, 140). The summary information is then transmitted to the service center 14 (step 142 in FIG. 2B). As shown in FIG. 6, the clerk at the service center is presented with a screen displaying summary information which includes the identity of the biller, the customer name, the customer account number, the payment due date and the amount owed (step 144). The example screen of FIG. 6 also includes a special alert 53 regarding a past due amount

To make the biller listed on the summary screen a “favorite” biller (step 146), the clerk clicks on the option 47 within the bill information box 48 shown in FIG. 6. The bill payment server computer 42 then updates the biller database to indicate that the currently listed biller is a favorite (step 148).

If the amount to be paid differs from the amount owed, the clerk is prompted to enter the amount paid in the dialog box 50, and the dialog box 52 prompts the clerk to enter the type of processing desired by the customer (step 150). Once the amount paid is entered by clicking on the button 54, the transaction is passed back to the bill payment server computer 42 where validations are performed (step 152).

If “priority” service was requested (step 154), the bill payment server computer 42 refers to the biller's master record in the biller database 44 to determine if there is an additional charge associated with a priority payment or if additional information is required to process the payment manually (step 156). Such additional information may include date of birth and the last four digits or the payee's Social Security Number.

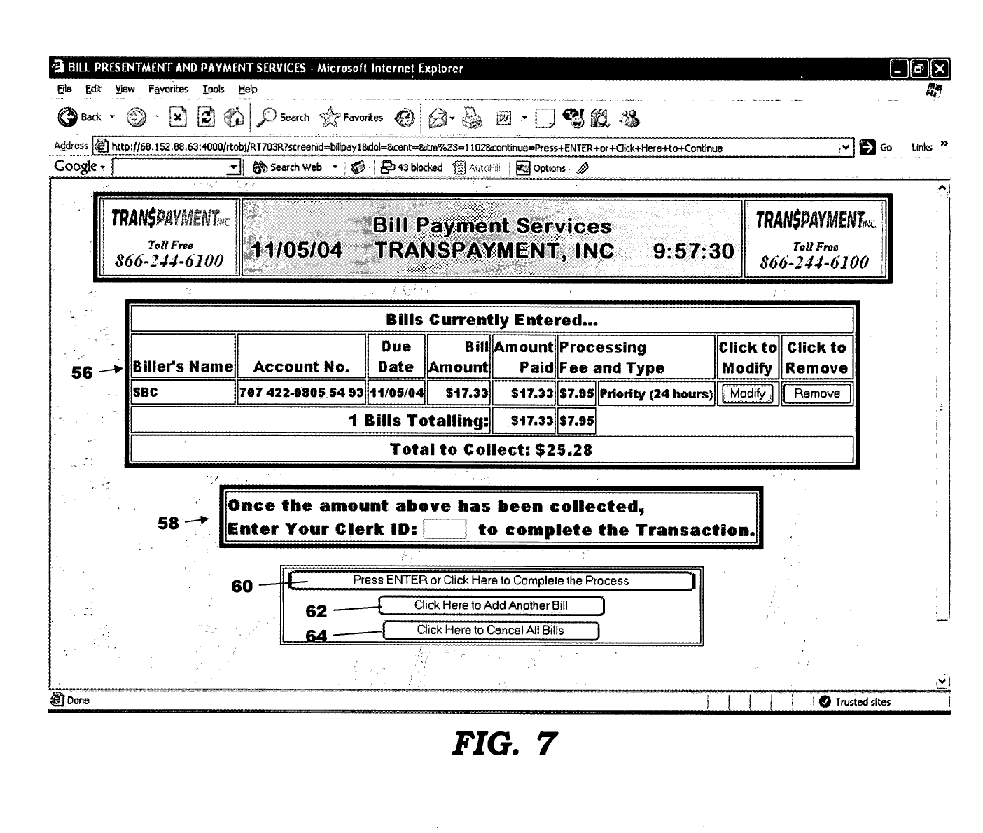

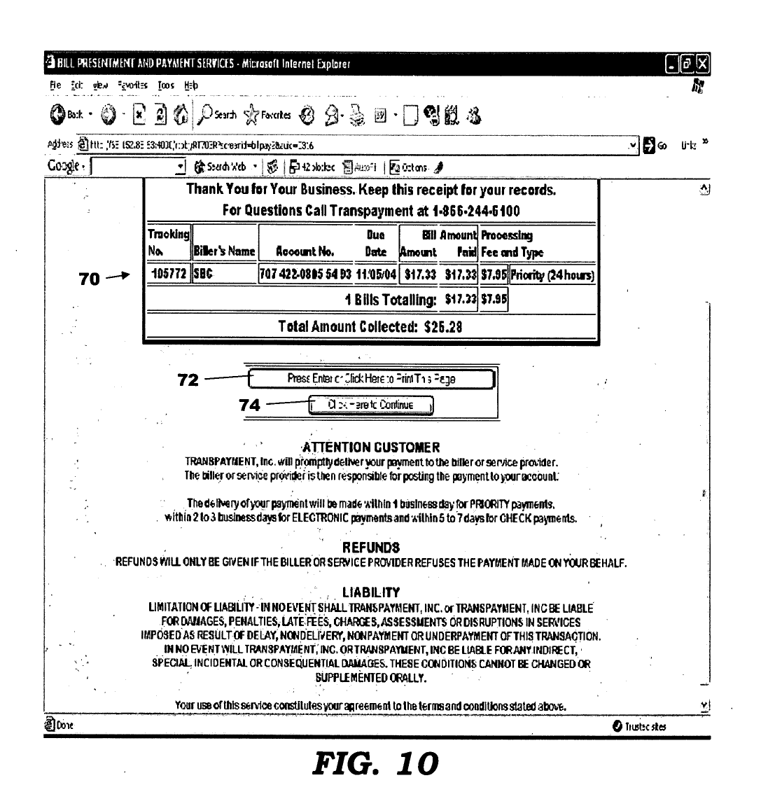

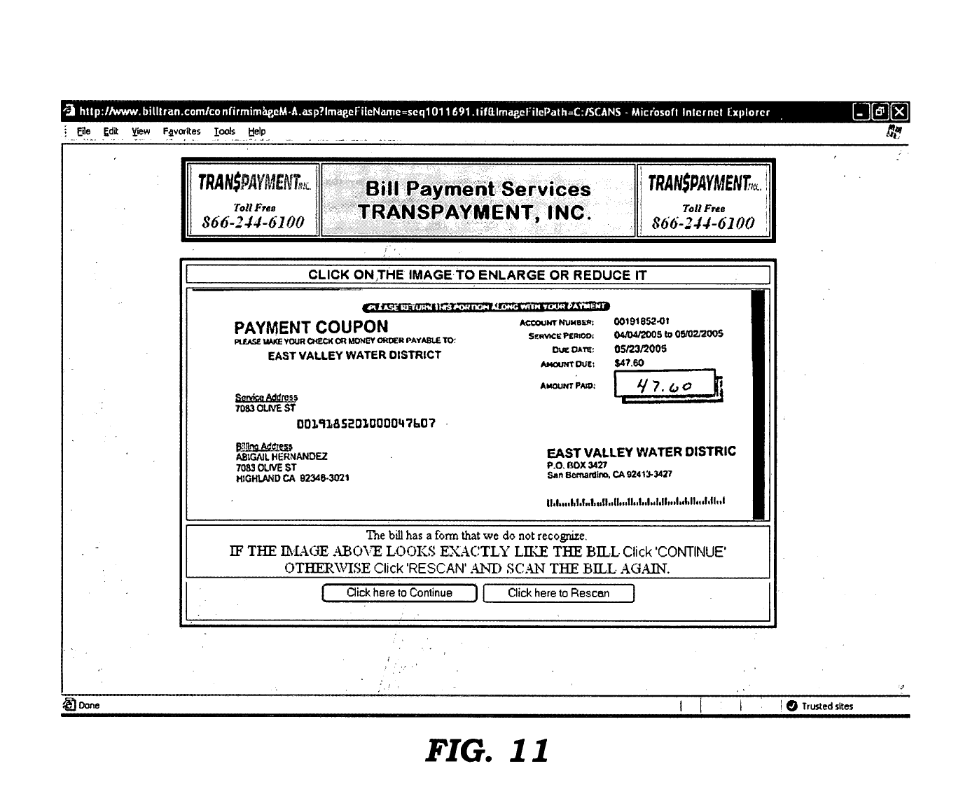

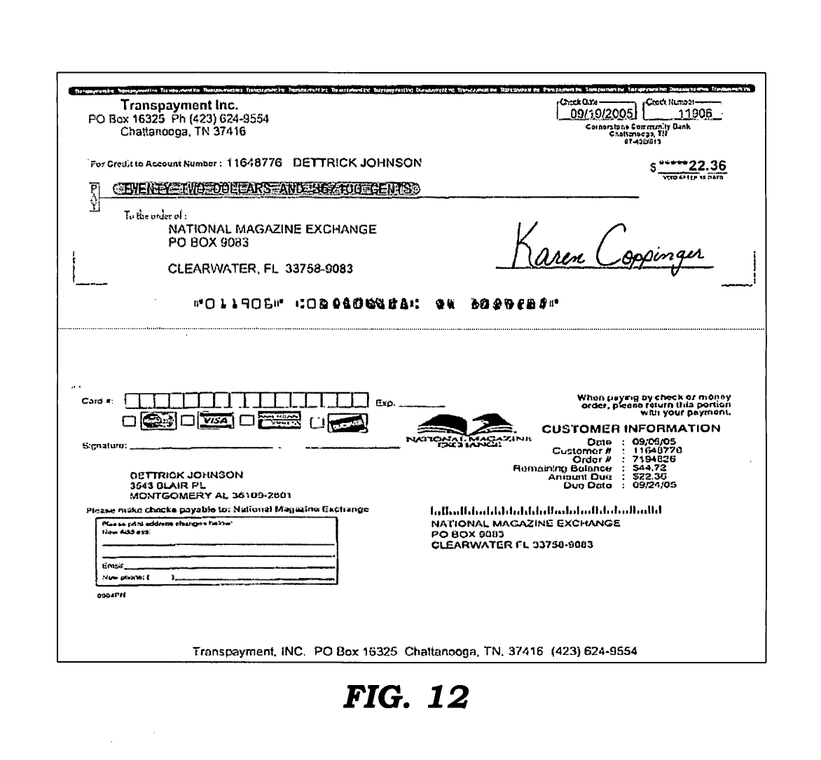

Once complete and validated, the transaction is added to a summary screen as shown in FIG. 7 (step 158). If additional charges are due or additional information is needed, this screen communicates the charge or provides fields to enter the information. From this screen, the clerk may choose to enter another bill (step 160), remove or modify any bills previously entered or enter their Clerk ID to complete the process. When all the payment information has been entered and verified, the clerk collects the payment due from the customer, enters the clerk ID number, and clicks a button on the screen to signal that the process is complete (step 162). In the preferred embodiment of the invention, the biller database 44 is then updated with the information from the transaction (step 163). A receipt record such as shown in FIG. 10 is then presented which details each transaction entered (step 164 in FIG. 2D). This screen may be printed and given to the customer as a receipt (step 166).

When the process at the service center computer 24 is completed, the bill payment server computer 42 proceeds to initiate the payment of the bill. In the preferred embodiment, completed transactions are paid using one of three methods: (1) electronic payments, (2) check payments and (3) priority payments. Electronic payments are preferably batched into a data file and sent to a consolidator for processing (step 168 in FIG. 2D). In the preferred embodiment, the consolidator initiates an electronic funds transfer from the bill payment service bank account 18 to the biller's bank account 20 (step 170). Priority payments are preferably handled manually at the bill payment service center 14. These expedited payments are made by calling the biller or going online to the biller's website and remitting the funds to the biller via credit card or company check draft (steps 172, 174). In the preferred embodiment of the invention, the biller database 44 is then updated with the payment information from the transaction (step 175). Regardless of the payment type, the preferred embodiment of the invention forwards a record of the transaction to the biller 12 (step 178).

When payment is made by check, the check is printed with the customer's name and account number and the check is mailed to the biller (step 176). In a most preferred embodiment of the invention, a copy of the scanned image of the bill is also printed on a tear-away stub attached to the check, an example of which is depicted in FIG. 12. In this way, the biller can easily match the check with the bill so that the payment is accurately credited to the payee's account.

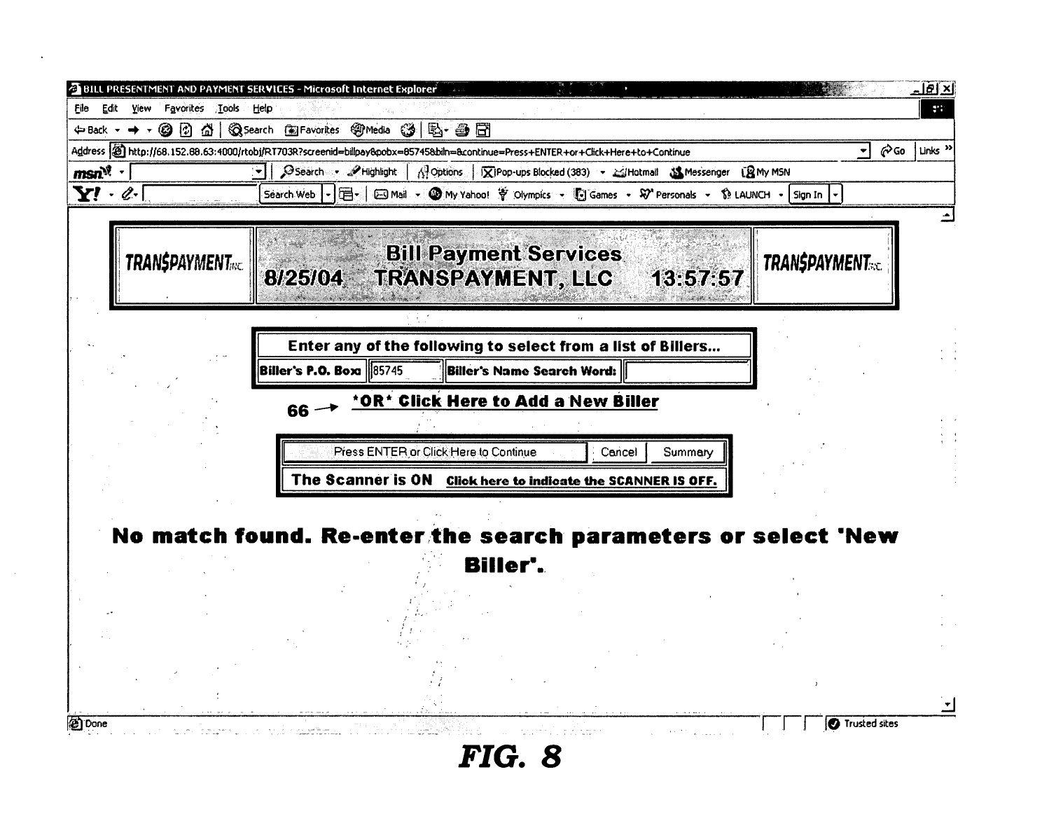

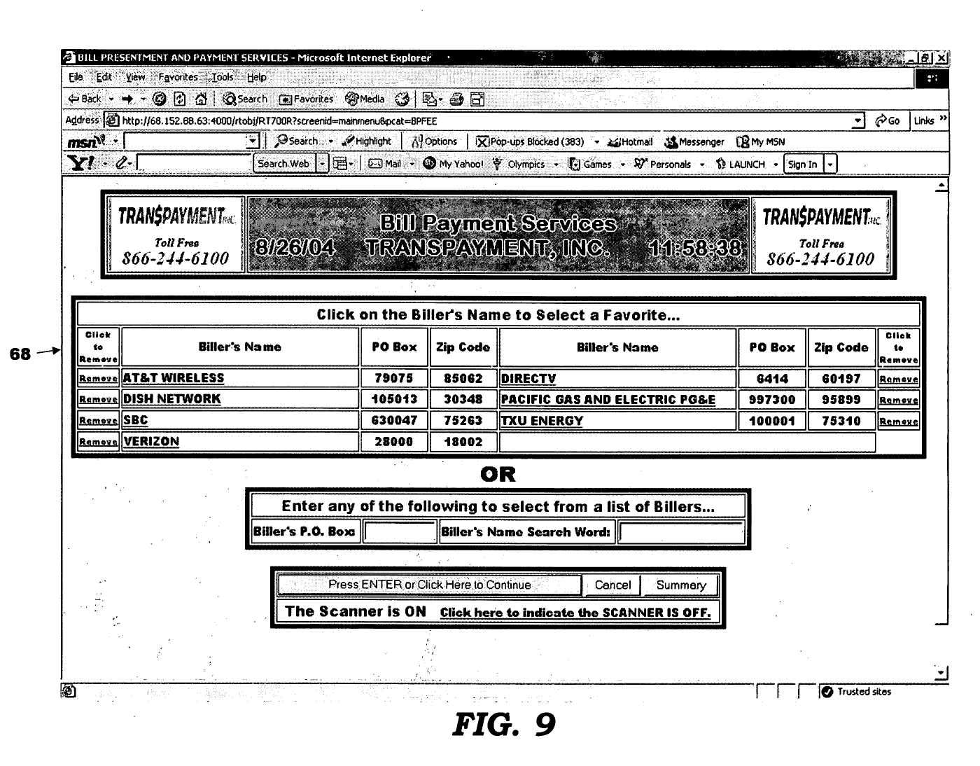

Referring again to FIG. 2A, if no matching biller is found at step 104, a screen such as depicted in FIG. 8 is displayed on the display device 26 at the service center (step 180 in FIG. 2C). This screen provides the clerk the option of adding a new biller by clicking the link 66 (step 182). When this option is selected, a prompt is presented to the clerk to scan the bill (step 184). The scanned image of the bill is presented to the clerk on the display device 26 (step 186) and the clerk is prompted to indicate whether the image is clear and undistorted (step 188). If the image is correct, the clerk keys in the amount to be paid (step 190) and confirms the amount paid is correct (step 192). Payment is then collected from the customer, the clerk enters the clerk ID number (step 194) and processing continues at step 164 in FIG. 2D.

In a new biller situation, the bill image scanned at step 184 is also transmitted to the bill payment service 16 where the associated transaction is flagged for new biller processing (step 196). In the preferred embodiment, this processing involves a review of the image by an analyst and creation of a new biller record associated with the image (step 198). When a new biller record is added, that biller becomes available in the biller search process (step 104 in FIG. 2A) or available to be added to the Favorites list. As part of the new biller procedure, the biller 12 is contacted to identify an electronic funds transfer account and bank routing information for the biller 12 (step 200), and that information is entered into the biller database 44 (step 202).

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of processing payment of a bill on behalf of a payee to a billing entity that issued the bill, the method comprising:
(a) generating an electronic image of the bill at a service center;
(b) transmitting the image of the bill from the service center to a central bill payment service via a communication network;
(c) extracting bill payment information from the image of the bill at the central bill payment service;
(d) designating a monetary amount to be paid to the billing entity based at least in part on the bill payment information; and
(e) initiating payment of the monetary amount to the billing entity on behalf of the payee.

2. The method of claim 1 where step (c) further comprises:
(c1) identifying fields within the image of the bill containing portions of the bill payment information;
(c2) recognizing characters within the fields; and
(c3) extracting the bill payment information from the characters.

3. The method of claim 1 where step (e) further comprises:
(e1) offering a plurality of options to the payee for paying the monetary amount to the billing entity;
(e2) receiving instructions from the payee regarding a selection of at least one of the plurality of options; and
(e3) paying the monetary amount to the billing entity according to the selection made by the payee.

4. The method of claim 3 where step (e1) further comprises offering payment by electronic funds transfer, payment by check, and priority payment via at least one of a credit card account and a debit card account.

5. The method of claim 1 further comprising storing the image of the bill in a bill image database in association with the bill payment information.

6. The method of claim 1 wherein step (e) further comprises providing the image of the bill to the billing entity when payment of the monetary amount is made by check.

7. The method of claim 1 further comprising entering at the service center information from the bill regarding an identity of the billing entity, displaying at the service center a list of billing entities determined based upon the entered information from the bill and selecting from the list one of the billing entities to which payment of the bill is to be made.

8. The method of claim 1 further comprising generating a receipt of the bill payment transaction for the payee.

9. An apparatus for processing payment of a bill on behalf of a payee to a billing entity that issued the bill, the apparatus comprising:
means provided at a service center for generating an electronic image of the bill;
means for transmitting the image of the bill from the service center to a central bill payment service via a communication network;
means provided at the central bill payment service for extracting bill payment information from the image of the bill;
means provided at a service center for designating a monetary amount to be paid to the billing entity based at least in part on the bill payment information; and
means for initiating payment of the monetary amount to the billing entity on behalf of the payee.

10. The apparatus of claim 9 wherein the means for extracting bill payment information further comprises:
means for identifying fields within the image of the bill containing portions of the bill payment information;
means for recognizing characters within the fields; and
means for extracting the bill payment information from the characters.

11. The apparatus of claim 9 wherein the means for paying the monetary amount further comprises:
means for offering a plurality of options to the payee for paying the monetary amount to the billing entity;
means for receiving instructions from the payee regarding a selection of at least one of the plurality of options; and
means for paying the monetary amount to the billing entity according to the selection made by the payee.

12. The apparatus of claim 9 further comprising means provided at the central bill payment service for storing the image of the bill in association with the bill payment information.

13. The apparatus of claim 9 further comprising means for providing the image of the bill to the billing entity when payment of the monetary amount is made by check.

14. The apparatus of claim 9 further comprising means provided at the service center for entering information from the bill regarding an identity of the billing entity, means provided at the service center for displaying a list of billing entities determined based upon the entered information from the bill and means provided at the service center for selecting from the list one of the billing entities to which payment of the bill is to be made.

15. The apparatus of claim 9 further comprising means provided at the service center for generating a receipt of the bill payment transaction for the payee.

16. An apparatus for processing payment of a bill on behalf of a payee to a billing entity that issued the bill, the apparatus comprising:
a service center computing system in communication with a communication network, the service center computing system including:
an image scanning device for generating an electronic image of the bill; and
a service center computer connected to the scanning device, the service center computer for receiving the image of the bill from the image scanning device, for transmitting the image of the bill via the communication network, and for designating a monetary amount of the bill to be paid to the billing entity; and
a bill payment service computing system in communication with the communication network, the bill payment service computing system including:
a bill payment server computer for receiving the image of the bill from the communication network, extracting bill payment information from the image of the bill and initiating payment of the monetary amount to the billing entity on behalf of the payee; and
a billing entity database for storing the bill payment information.

17. The apparatus of claim 16 wherein the bill payment server computer includes software for identifying fields within the image of the bill containing portions of the bill payment information, for recognizing characters within the fields and for extracting the bill payment information from the characters.

18. The apparatus of claim 16 wherein
the service center computer offers to the payee a plurality of options for paying the monetary amount to the billing entity, receives instructions regarding a selection of at least one of the plurality of options and provides the instructions to the bill payment server computer via the communication network; and
the bill payment server computer receives the instructions regarding the selection of one of the plurality of options and initiates payment of the monetary amount to the billing entity according to the selection.

19. The apparatus of claim 16 wherein the bill payment server computer provides the image of the bill to the billing entity as part of the bill payment transaction when payment of the monetary amount is made by check.

20. A method of processing payment of a bill on behalf of a payee to a billing entity that issued the bill, the method comprising:
(a) generating an electronic image of the bill at a service center;
(b) transmitting the image of the bill from the service center to a central bill payment service via a communication network;
(c) printing a check payable to the billing entity in payment of the bill; and
(d) printing the image of the bill on the check.
